(19) United States
(12) Patent Application Publication
(10) Pub. No.: US 2011/0214600 A1
(43) Pub. Date: Sep. 8, 2011

(54) INDICATOR

(75) Inventors: Eero Hurme, Espoo (FI); Then Sipiläinen-Malm, Espoo (FI)

(73) Assignee: Teknologian tutkimuskeskus VTT, Espoo (FI)

(21) Appl. No.: 12/999,245

(22) PCT Filed: Jun. 17, 2009
(86) PCT No.: PCT/FI09/50535

§ 371 Date: May 26, 2011

(30) Foreign Application Priority Data
Jun. 18, 2008 (FI) 20085611

(51) Int. Cl. G01D 21/00; B05D 5/06; B05D 3/06

(52) U.S. Cl. 116/201; 116/206; 427/162; 427/555; 427/553

(57) ABSTRACT

The invention relates to an indicator comprising a substrate and an optical grating structure fabricated on the substrate, the grating structure being formed from an indicator material comprising a binder and deliquescent salt and varying in volume by the effect of moisture. Further, the invention relates to a method for fabricating an indicator wherein a substrate is coated by an indicator material forming an optical grating structure, and the optical grating structure is fabricated onto the substrate, and use of an indicator for detecting quality and/or authenticity. Furthermore, the invention relates to a package and a method for detecting a change induced by moisture without breaking the package.

### FIELD OF THE INVENTION

The invention relates to an indicator, a method for fabricating same, use of an indicator to detect quality and/or authenticity, a package, and a method for detecting a change induced by moisture without breaking the package.

### BACKGROUND OF THE INVENTION

To detect a leakage, variation in the oxygen content or gas composition of a package or spoilage of a product in the package, it is known to use an indicator which changes color to indicate variations in the conditions of the package. It is known from the prior art to use in packages various indicators which react for example as a result of variation in the oxygen or moisture introduced in the package or change in the pH, indicating a change of color. For example, publication FI 94802 describes various leak indicators for use in packages.

A problem with the known indicators is their restriction merely to chemical reactions inducing a color change.

Publication WO2007060648 discloses a sensor with a holographic element and comprising a grating or hologram recorded in a holographic medium, wherein at least one physical and/or chemical and/or optical characteristic of the holographic element or the image produced by it varies as a result of variation in humidity in the air surrounding the element. The moisture-sensitive hologram may be combined with a package to provide a moisture indicator.

In addition to that presented above, another problem of an indicator comprising a hologram is that the variation induced by moisture is horizontal, which makes it difficult to detect the variation in the physical and/or chemical characteristic, such as a color change, and/or in the optical characteristic by the naked eye, because it is affected by the angle of view. Furthermore, the hologram must be fabricated separately before it can be added to a package/substrate. In addition, the variation in the physical and/or chemical characteristic, such as a color change, and/or in the optical characteristic in the hologram is normally reversible. After the variation has been reversed, such an indicator will not indicate any earlier exposure of a product to spoiling conditions.

### OBJECTIVE OF THE INVENTION

The objective of the invention is to disclose a novel multipurpose indicator which indicates reliably the quality and/or authenticity of a packaged product, such as a foodstuff, drug, cosmetics or electronics product. The indicator allows detection of a leakage, ageing, disadvantageous storage conditions and/or moisture in a product package. Another objective of the invention is to disclose a novel indicator and package for easier tracking of the product than before. One specific objective of the invention is to alleviate the problems referred to above.

### SUMMARY OF THE INVENTION

The indicator according to the invention is characterized by what has been presented in claim 1.

The method for fabricating an indicator according to the invention is characterized by what has been presented in claim 11.

The use of an indicator according to the invention is characterized by what has been presented in claim 13.

The package according to the invention is characterized by what has been presented in claim 14.

The method according to the invention for detecting a leakage induced by moisture without breaking the package is characterized by what has been presented in claim 16.

The indicator according to the invention comprises a substrate and an optical grating structure fabricated onto the substrate. The optical grating structure is formed from indicator material comprising a binder and deliquescent salt and varying in volume by the effect of moisture. The optical grating structure is fabricated by any known fabrication technique, such as the hot pressing, laser or UV lithography technique.

The indicator material in the optical grating structure comprising a binder and deliquescent salt reacts to moisture by variation of volume. Variation and loss of the grating effect, induced by change in the dimensions of the grating, is indicative of a change in the conditions. The reaction is irreversible, i.e. the grating is not restored.

The binder and the deliquescent salt form a moisture-absorbing agent which expands by the effect of moisture.

Deliquescence refers to a phenomenon in which a soluble agent absorbs water vapor from the atmosphere and forms a solution. The transition of state from solid matter to aqueous solution occurs when the relative humidity exceeds the so-called deliquescence point which is specific of the agent.

A hygroscopic agent that absorbs or desorbs moisture, depending on the relative atmospheric humidity, a non-hygroscopic agent, an agent that expands by the effect of heat and/or their mixtures are used as the binder. The binder binds together the components of the indicator composition and fastens the indicator on a substrate. Thermoplastic polymer such as polyolefin, polyvinyl halide, styrene polymers such as styrene acrylate, acrylic polymer such as polyacrylate, polyacrylamide, acrylic polyol, polyacrylic acid and/or acrylate resin, polyhydroxyethyl methacrylate, other chain polymers, for example polyvinyl alcohol and various copolymers thereof, polymers based on polyethylene glycol, polyvinyl pyrrolidone and/or polyvinyl acetate, polyether, polyester, sulpho polyester, polyketone, polyamide, polyurethane, polysiloxane and/or mixtures thereof may be selected as the binder. The thermoplastic polymer may be hygroscopic or non-hygroscopic. The polymers may be prepared into a gel by crosslinking. Also gelatine-type moisture-absorbing agents that are insoluble in water, equivalent gelling agents of plant origin, for example carragheen, other binders of plant origin such as starch and cellulose, for example modified starch and modified cellulose, agarose and other moisture-absorbing agents, for example bentonite and silica gel, may be used as the hygroscopic binder.

Polyvinyl alcohol or a copolymer thereof, polyester, polyketone and/or mixtures thereof are preferably used as the hygroscopic binder.

An inorganic salt and/or mixtures of salts of hygroscopic nature are used as the deliquescent salt. A halide, nitrate and/or carbonate salt of an alkali metal, alkali earth, aluminum and/or ammonium and/or other equivalent moisture-absorbing salt may be selected as the salt. Typical deliquescent salts include sodium, potassium, magnesium, calcium and/or ammonium chloride.

Calcium chloride, potassium chloride and/or ammonium chloride is preferably used as the deliquescent salt.

A hygroscopic binder and/or non-hygroscopic binder may be used with the deliquescent salt in the indicator material forming a grating structure. If a deliquescent salt is used in the grating structure, the binder need not be hygroscopic.

To improve visibility of the grating pattern, dyes, fillers and/or other additives used in indicators, such as moisture regulators and softeners, may be added to the indicator material forming the grating structure. Any dyes, for example soluble oxidation and reduction dyes, pH dyes and/or mixtures thereof known in the art, may be used as the dye. Any dye that changes color by the effect of variation in moisture, oxygen in the air, pH and/or light is possible. Such a dye may be selected for example from bromocresol green, neutral red, methylene blue and/or the like. For example talc, titanium oxide, carbon black and/or the like may be used as the filler. The moisture regulator or softener may include polyethylene glycol and derivatives thereof, glycerol, 1,2- and 1,3-propane diole, sorbitol, erythritol and/or mixtures thereof, preferably 1,3-propane diole.

The indicator material forming a grating structure is fabricated in varying substance ratios from different binders and deliquescent salt and optionally other additives, such as dyes and fillers, so as to provide a sufficiently sensitive and distinct variation of volume.

In one embodiment, deliquescent salt was used in an amount of 5 to 30% by weight, preferably 10 to 25% by weight of dry matter in the indicator material forming a grating structure. The employed substrate may be made from package material based on plastic, chemical pulp and/or glass and/or any other generally used package material. The plastic material may be made from thermoplastic polymer, for example polyolefin such as polyethene and polypropene, polyester such as polyethylene terephthalate, polystyrene, polyamide or any other plastic material generally used as package material and/or mixtures thereof. The material based on chemical pulp may include for example surface-treated or untreated paper, board, film material based on dissolving pulp or other material based on chemical pulp. Further, the substrate material may be formed from a laminate or other type of composite of the above-mentioned or other known package materials. The material may also be coated. The substrate is preferably made from flexible plastic material such as polyester and polyolefin and/or a mixture thereof.

The substrate is the package material and/or a separate bedding added to the package.

In one preferred embodiment, the indicator is a moisture indicator comprising a preferably hot-pressed optical grating structure fabricated from a mixture of polyvinyl alcohol and calcium chloride salt on a separate polypropene and/or polyterephthalate film.

The indicator is fabricated by coating a substrate with indicator material forming an optical grating structure and comprising a binder and deliquescent salt and varying in volume by the effect of moisture. Any application, coating and/or pressing method known in the art may be used to coat the substrate. Then, the optical grating structure is fabricated onto the substrate coated with the indicator material forming the grating structure.

The optical grating structure may be fabricated by any known method for fabricating a grating, such as the hot pressing technique, laser technique or UV lithography, preferably hot pressing.

The coated substrate may be dried and, if required, stored before fabricating the grating. Storage takes place preferably in dry conditions.

Hot pressing may be performed by the embossing technique and/or any other hot pressing method known in the art. In hot pressing, a grating pattern is pressed on the indicators. Any pattern may be fabricated as a grating that refracts light. The grating pattern may be a linear, round and/or angular pattern. A pattern in which variation and/or loss of the grating is easily detectable is preferably used as the grating pattern.

The indicator may be formed by fabricating it directly on the package material. In this case, the optical grating structure may be fabricated, at the time of packaging or before packaging the product, directly on the package by hot pressing, laser technique or UV lithography.

The indicator may also be formed by hot pressing, laser technique or UV lithography on a separate substrate bedding which is added to the package at the time of packaging. The material of a separate substrate bedding is any of the above-mentioned package materials. A separate indicator is preferably in the form of a sticker and/or equivalent label which is easy to add to the package in connection with packaging.

The indicator, separate or added to the package material, containing a finished optical grating structure, should be stored in dry conditions.

A protective film against humidity made from a material which transmits very little or not at all moisture may also be added to the indicator for the period of storage before introduction to use.

The indicator is added to a package before the package is closed and it is reactive immediately after the product has been packaged. The indicator added to a package reacts to humidity brought into the package from outside, indicating exposure of the package to moisture, for example due to opening or breaking of the package, by variation of the optical grating effect. The indicator reacts to moisture which has accessed due to breaking of the package, indicating a leakage. The indicator may also react to an elevated storage temperature of the product.

The package may be preferably used for packaging foodstuffs, drugs, cosmetics or electronic products.

In the package and the indicator, the indicator material of an optical grating structure reacts to moisture by variation of volume. Variation and loss of the grating effect indicates a change in humidity. The variation of the grating effect may be detected visually or scanned automatically by optical or other scanning techniques without breaking the package.

Information varying by the effect of moisture may also be printed in printing ink onto the indicator to enhance the optical effect.

The indicator is preferably used in packages for foodstuffs, drugs, cosmetics and electronic products to detect the quality, correct storage conditions and/or authenticity of the products. Quality refers to e.g. intactness and sealing of the product package and appropriate storage conditions e.g. in terms of humidity. The indicator may also be used in posters, stickers, envelopes, games and other equivalent products as an effective means of sales promotion or to indicate their authenticity.

The invention allows fabrication of a simple multipurpose indicator which is easy to use and operational directly after packaging and which is based on a reliable irreversible reaction. Furthermore, the visual effect and color of the indicator according to the invention can be easily modified. Further, by the indicator according to the invention, a product may be provided with a functional characteristic representing the authenticity/origin of the product already during its production process, whereby the effect cannot be added to the product later. The indicator can be fabricated from ingredients which are completely harmless to health. Also, the components and serial production of the indicator according to the invention are affordable in expenses.

In the following section, the invention will be described in detail by means of exemplifying embodiments.

### LIST OF FIGURES

FIG. 1 presents the indicator according to the invention.

### DETAILED DESCRIPTION OF THE INVENTION

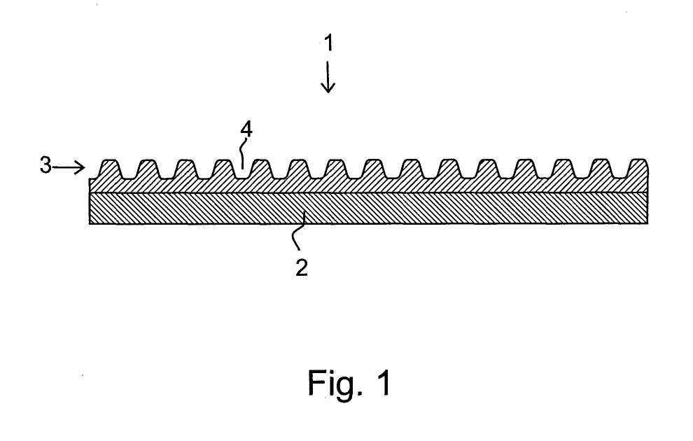

FIG. 1 shows part of an indicator 1 which may be added to a package of a food, drug, cosmetic or electronic product. The indicator consists of a substrate 2 which is normally the package material, e.g. polypropene or other polyolefin, polyterephthalate or other polyester, or a combination and/or mixture thereof. Further, the indicator consists of an optical grating structure 3 which has been hot-pressed on the surface of the substrate. In a moisture indicator, the indicator material of the optical grating structure consists of a mixture of a hygroscopic polymer, e.g. polyvinyl alcohol, which is a thermoplastic material so that a grating pattern may be hot-pressed thereupon, and a deliquescent salt, e.g. a calcium chloride solution or other chloride salt. The mixture may also contain a dye, moisture regulator and/or softener and filler. The hot-pressed indicator fabricated according to the invention constitutes a large number of equidistant gratings wherein the distance from each other (=grating period) 4 and the height 4 of the gratings is normally in the range of about 100 to 700 nanometers, but it may also be in the range of a few nanometers. The hygroscopic polymer and deliquescent salt absorb moisture from the atmosphere depending on the relative atmospheric humidity. The transition of the calcium chloride from solid matter into aqueous solution occurs when the relative humidity exceeds the deliquescence point which is about 40%. Calcium chloride exhibits a number of hydrous forms until it reaches the saturation point, after which it forms a saturated solution. Elevated humidity is visible in the optical grating structure as expansion of the volume of the indicator material, whereupon the dimensions of the gaps in the grating change, and the gaps eventually disappear, which is indicative of elevation of the humidity past a specific limit. The reaction is irreversible.

The loss of the grating pattern of the indicator indicates a consumer that the product has been exposed to atmospheric humidity e.g. on a shop shelf.

### Example 1

A test was carried out to study the compatibility of the binder and the salt of the indicator. The following salts were used as the deliquescent salts:
Humidity at which liquefies

| CaCl₂ | about 40 |
|---|---|
| MgCl₂ | about 40 |
| NH₄Cl* | 60 to 80% |
| Nacl | 75% |
| KCl | 80-90% |

Polyvinyl alcohol, polyacrylic acid, polyvinyl pyrrolidone, polyester, polyketone, acrylic polyol, sulpho polyester, commercial polymer emulsion, styrene acrylate polymer emulsion and acrylate resin were used as binders.

The compatible binders and salts are presented in Table 1.

| binder | MgCl₂ | CaCl₂ | NaCl | NH₄Cl* | KCl |
|---|---|---|---|---|---|
| polyvinyl alcohol | X | X | | X | X |
| polyacrylic acid | | | X | X | X |
| polyvinyl pyrrolidone | X | X | X | X | X |
| commercial polyester | | X | | X | |
| commercial polyketone | | X | | X | |
| commercial acrylic polyol | | | | X | |
| commercial sulpho | | | | X | |
| polyester | | | | | |
| commercial polymer | | | | X | |
| emulsion | | | | | |
| commercial styrene | | | X | X | X |
| acrylate polymer emulsion | | | | | |
| commercial acrylate resin | | | | X | X |
| another commercial styrene | | | X | X | |
| acrylate emulsion | | | | | |

X = compatible

### Example 2

A test was carried out to study the effect of the binder and salt components of the indicator on the variation of the optical grating effect of the indicator at relative humidity.

Two combinations of the salt and the binder were used in the test:

I: CaCl₂ and a polyketone binder and

II: CaCl₂ and a polyvinyl alcohol binder,

which were formulated into indicator solutions and applied on a plastic film by a rod applicator. A polyester plastic film was found best in terms of hot pressing and application of the solutions. The coated films were dried and stored together with drying agent in plastic pouches and exsiccator. A honeycomb grating pattern was hot-pressed onto the coated films by a Madag P2000 hot press. The variables included embossing temperature, time and pressure. The finished gratings were stored in dry conditions.

The gratings were photographed and their operation tested by holding them in cabinets with relative humidity of 22.6% and 84%. Variation in the optical grating pattern of the indicator was observed after 3 h, 1 d and 4 d from the onset of the test.

The results are presented in Table 2.

| | |
|---|---|
| Indicator, | variation in grating pattern |

| RH % | 3 h | 1 d | 4 d |
|---|---|---|---|
| I, 22.6% | no variation | no variation | no variation |
| I, 84% | opacified | opacified | opacified |
| II, 22.6% | opacified | opacified | disappeared |
| II, 84% | disappeared | disappeared | disappeared |

### Example 3

The effect of the amount of salt on the reaction rate of a moisture indicator was studied in a series of indicators based on polyvinyl alcohol and added with different amounts of saturated CaCl₂ solution. The indicator material was applied on a PET/PP film on the PET side by a Hand Coater rod 2. The indicator material consisted of PVA, 1,3-propane diole, dye solution and saline solution. The results are presented in Table 3.

TABLE 3
Grating loss rate

| % saline | | | |
|---|---|---|---|
| solution | RH 80% | | RH 50% |
| 4.5 | 60 s | 35 s | about 10 s |
| 3.7 | 35 s | 55 s | about 20 s |
| 2.8 | 22 min | about 20 h | about 30 s |
| 1.9 | 16 min | 11 min | about 30 s slight |
| | | | discoloring |
| | | | 2.5 min pattern fades |
| | | | depending on grating |
| | | | pattern disappears 5 min to 3 h to |
| | | | 3 d |
| 0.9 | 35 min | 4 h | 60 s slight opacification |
| | | | 3 min pattern fades, remains |
| | | | slightly visible |

| | RH 55% | RH 28% |
|---|---|---|
| 4.5 | 10 min | max 1 d |
| 3.7 | 33 min | max 1 d |
| 2.8 | no variation | no variation |
| 1.9 | no variation | no variation |
| 0.9 | no variation | no variation |

In the test it was discovered that variation rates measured in moisture cabinets are not completely reliable, in particular with fast indicators, because, after opening, humidity in the cabinets did not have time to be restored. Also, steadiness of hot pressing and/or layer thickness of the indicator material are of importance for the operation of the indicator.

### Example 4

A grating pattern of a moisture indicator was fabricated in the test from a solvent-based indicator material comprising polyketone, polyacrylic acid, CaCl₂ and methylene blue. The indicator material was applied on polyester plastic by a rod 4.

The hot-pressed grating patterns were well visible. The indicator opacified quickly in a room of 50% RH, but the grating patterns did not disappear completely in 3 days.

The invention is not limited merely to the exemplary embodiments referred to above; instead, many variations are possible within the scope of the inventive idea defined by the claims.

1. An indicator comprising:
a substrate and
an optical grating structure fabricated on the substrate, the grating structure being formed from indicator material comprising a binder and deliquescent salt and varying in volume by the effect of moisture.

2. The indicator according to claim 1, wherein the binder is a hygroscopic binder.

3. The indicator according to claim 2, wherein the hygroscopic binder is a thermoplastic polymer.

4. The indicator according to claim 3, wherein the thermoplastic polymer is polyvinyl alcohol or its copolymer, polyester, polyketone and/or their mixture.

5. The indicator according to claim 1, wherein the deliquescent salt is an inorganic alkali metal, alkali earth, aluminum and/or ammonium halide, nitrate and/or carbonate salt and/or their mixture.

6. The indicator according to claim 5, wherein the deliquescent salt is calcium, potassium and/or ammonium chloride.

7. The indicator according to claim 1, wherein the indicator material forming a grating structure also comprises a binder, dye, filler and/or other additives.

8. The indicator according to claim 1, wherein the substrate is package material.

9. The indicator according to claim 1, wherein the substrate is a separate bedding added to a product package.

10. The indicator according to claim 1, wherein the indicator is a moisture indicator.

11. A method for fabricating an indicator, the method comprising the steps of:
coating a substrate with an indicator material forming an optical grating structure and containing a binder and deliquescent salt and varying in volume by the effect of moisture;
fabricating the optical grating structure on the substrate coated with the indicator material forming a grating structure.

12. The method according to claim 11, wherein the optical grating structure is fabricated by hot pressing, laser technique or UV lithography.

13. Use of the indicator according to claim 1 for detecting quality and/or authenticity.

14. A package for detecting a change induced by moisture, wherein the package is formed by adding the indicator according to claim 1 to the package at the time of packaging.

15. The package according to claim 14, wherein the package is a food, drug, cosmetic or electronic package.

16. A method for detecting a change induced by moisture in a package without breaking the package, wherein the package is formed by adding the indicator according to claim 1 to the package at the time of packaging, and variation in the humidity of the package is indicated by a change in the grating effect of the indicator.

17. The method according to claim 16, wherein the change is detected visually or scanned automatically by optical or other scanning techniques.
